(19) United States
(12) Patent Application Publication
(10) Pub. No.: US 2010/0070995 A1
(43) Pub. Date: Mar. 18, 2010

(54) SYSTEM AND METHOD OF RENDERING ADVERTISEMENTS BY EMPLOYING SWITCHING-ON SCREEN OF TELEVISION

(76) Inventor: Yang Pan, (US)

Correspondence Address: Yang Pan;Intellectual Power Pte Ltd, No. 14 Robinson Road #06-01,, Far East Finance Building, Singapore, 048545, SG

(21) Appl. No.: 12/210,218

(22) Filed: Sep. 15, 2008

(51) Int. Cl. H04N 7/025; H04N 5/44

(52) U.S. Cl. 725/34; 348/734; 348/E05.096

(57) ABSTRACT

Method and system are disclosed to render targeted advertisement to a user by employing a television terminal, which is connected to an advertising server through a computing device. Furthermore, a remote control integrated with a sensory system that senses the user's action of holding the device is disclosed. A signal is sent to the computing device connected to the television terminal when the user is holding the remote controller. The computing device then switches on the terminal and sends an advertisement for displaying on the screen of the terminal. After receiving the user's selection of a TV channel, the programming replaces the displayed advertisement while the displayed message is moved into a “picture-in-picture” with a smaller display window. The user may select the advertisement in the window for further reviewing of more detailed information in a video/audio format. The window and displayed advertisement is removed from the screen after a predetermined period of time if the user is not intrigued by the message. Various embodiments of the sensory systems have been disclosed. In another embodiment, the remote control has the capability to collect biometrical data of the user. The data is sent to the computing device for further analysis to identify a specific user from a group. Targeted advertisements are then delivered based upon the determined user's identity.

### CROSS-REFERENCE TO RELATED APPLICATIONS

Not applicable.

### BACKGROUND

1. Field of Invention

This invention relates generally to advertising. More specifically, the invention relates to method and system for providing advertisements by employing an information retrieval system based upon television connected a communication network.

2. Description of Prior Art

Advertising using traditional media, such as television, radio, newspapers and magazines, is well known. Unfortunately, even when armed with demographic studies and entirely reasonable assumptions about the typical audience of various media outlets, advertisers recognize that much of their advertisement budget is simply wasted. Moreover, it is difficult to identify and eliminate such waste. The Internet, and particularly, World Wide Web (Web), has experienced tremendous growth during recent years. Advertising over more interactive media had become popular. The Web allows users to retrieve and access text, graphics, audio, video, and other information from remote servers. The Web has become a valuable source of news, educational resources, commercial information, entertainment, and the like. As for delivering commercial information to a user using the Internet, it has been found that advertisement in Web pages are most effective if they can be tailored and directed to segments of the population that are likely to be interested in advertised products and services. Because of the interactive nature of the Internet and the ability to easily insert graphical images in Web pages, there have been developed several prior arts to render targeted advertisements to the users.

One of the simplest methods of tailoring Internet advertisements to recipients is similar techniques used in television, radio and other media. In particularly, advertisements are selected to correspond to the subject matter of the Web page or other Internet resources. The U.S. Pat. No. 7,346,606 to Bharat disclosed an art for rendering advertisements to a user by monitoring user behavior and determining the user's topic of interest when the user is assessing the Internet through browsing Web pages.

Furthermore, mobile communication devices have gained significant popularity in recent years. Users are using the mobile device such as, for example, iPhone from Apple Inc, Cupertino, Calif., to assess the Internet services. Innovative methods for delivering advertisements to users by employing mobile communication devices have been disclosed. Among many applications, several arts have been proposed to render advertisements to users by using of idle screens of mobile devices. U.S. Pat. Nos. 5,913,040, 6,317,789, 6,539,429 to Rakavy et al disclosed prior arts to utilize the idle screen of a mobile device to display advertisement messages, which are delivered to the user's device without user's notification. The messages are displayed preferably as a screen saver. U.S. Pat. No. 6,363,419 to Martin, Jr. et al disclosed a method to display useful or commercial information on an idle screen. The idle content screen is switched to a default display screen when a user's input action is received. The default display screen is the gateway for the user to navigate to various application menus of the mobile device. US patent application 2004/0077340 by Forsyth and the application 2006/0156256 by Lee disclosed similar arts to use idle screens for displaying commercial information with the user's programmability on the displayed contents. In U.S. Pat. No. 7,369,864 to Vaananen, an art is disclosed by using of electronic short messaging method to deliver advertisement messages. The user is shown the message automatically, and he or she may delete it or receive further information on it with one single press of a dedicated key.

Among all electronic devices, television is still one of the most popular devices used by various users. Advertisements delivered to viewers through the television are typically broadcasted to the viewers without differentiation, which makes the advertisements less effective. In recent years, there is a trend that television program is delivered by using of communication network rather than more conventional means such as by broadcast and cables. Internet Protocol Television (IPTV) is a system where a digital television service is delivered using Internet Protocol over a network infrastructure such as for example, over a broadband connection. A general definition of IPTV is television content is received by a user through the technologies used for computer networks instead of being delivered through conventional means. More particularly, in IPTV, television programming is delivered as video contents, which is divided into data packets and streamed to consumers over the Internet. The IPTV stream of data packets is received by a set top box, which is connected to a subscriber's television. Typically, the set top box is connected to the Internet over a broadband connection.

IPTV provides greater control and flexibility to consumers than traditional TV distribution technologies. For example, because television programming is delivered point-to-point from a provider to a subscriber, a user may individually control programming being delivered. Also, because television programming is being delivered over the Internet, a user may receive IPTV program from around the world.

In various other digital television delivery systems, such as digital cable and satellite, digital data streams are delivered to a set top box which is connected to a television. These digital television delivery systems can provide various levels of control and flexibility to users.

IPTV and other digital television delivery systems offer greater control to service provider than traditional TV distribution technologies. Service providers can then provide personalized TV advertising. That is, service providers can target specific users or groups of users with customized advertisements based on viewing or purchasing habits of the users. The U.S. Pat. No. 6,463,595 to Hendricks et al disclosed a system to deliver targeted advertisements to different groups of viewers during the commercial breaks to improve the effectiveness of the advertisements. In the U.S. Pat. No. 6,718,551 to Swix et al, a method is disclosed for providing targeted advertisements to a user based upon tracking and storing and analyzing the viewer's selections. In the US patent application 2007/0291747 by Stern et al, a method is disclosed for user to user targeted advertising using a digital television delivery service. In the U.S. Pat. No. 7,269,837 to Redling et al., an art is disclosed for providing advertisement from a central database server connected to a global computer network to distributed sites via interactive television. A representative icon is presented to a subscriber on a television indicating an advertisement. When the icon is selected, advertisement information details are retrieved from storage in a local memory or from the server and presented to the user. In US patent application 2006/0031405 by Goldman et al, an art is disclosed for selecting and inserting advertisements in an information documents displayed to a user, wherein the selection is based at least in part on television programming viewed by the user.

All above mentioned prior arts have attempted to deliver targeted advertisements to a user by leveraging programmability of the interactive television. It should be noted that television is a home appliance and is typically shared by multiple family members, who may have different topic of interest. Therefore, it is desirable that the client system including the television terminal and a remote control can identify the identity of a user and can deliver the advertisements accordingly.

Accordingly, it is an object of the present invention to disclose a method to render advertisements to a user by employing an Internet-based information retrieval system including an advertising server and a client system with a computing device, a television terminal and a remote control.

It is a further object of the present invention to use the switching-on screen of the television terminal to deliver the advertisements to the user.

It is still a further object of the present invention to deliver the advertisements to the user by using the above mentioned system with a remote control, which provides means to determine the user's identity and enables the system to render a targeted advertisement to the identified user.

### SUMMARY OF THE INVENTION

The present invention provides system and method for rendering a targeted advertisement to a user of a television system connected to an advertising server via the Internet through a computing device such as a set top box. Internet Protocol Television (IPTV) is used as an exemplary case in the description, which should not limit the scope of the invention, which applies to the system with various types of digital TV system.

The present invention is based upon the Internet-based information retrieval system including an advertising server operated by an advertisement broker. The broker receives advertisements from advertisers. The advertisers are connected to the server via a communication network, which in many cases is the same network as the one connecting the client systems and the server and in many cases it may be different networks.

The client system comprises of a computing device, a television terminal and a remote control. The computing device comprises typically a set top box, which connects the television terminal and the server via a communication network such as, for example, the Internet. The set top box comprises of a processor, a file storage system and a communication device. In the present invention, the remote control includes a sensory system, which senses the user's action of holding the device and sends a signal to the set top box. After receiving the signal, the set top box selects an advertisement and controls an operation to switch on the television terminal and to display the message on the screen of the television terminal. A user's profile is stored in the set top box and the displayed message may be selected based upon the user's profile. In the case of multiple users for the television terminal, a sensory system integrating with the remote control is able to collect biometrical information associated with the user and to send the information to the set top box, which determines the user's identity based upon the received information.

In one embodiment, the sensory system is one or a plurality of finger-print sensors, which collects the user's finger prints when the user is holding the remote control. In another embodiment, the sensory system is an image capturing device installed onto the front side of the remote control. The device captures the facial image of the user when the device is hold by the user. The remote control sends collected biometrical information to the set top box, which determines the user's identity based upon the received information.

When a user is identified, a targeted advertisement is selected and is displayed on the television terminal. The user has a high chance to view the displayed message while selecting a television programming as usual. When a TV channel is selected, the selected programming replaces the displayed advertisement on the screen. In the same time, the displayed advertisement is moved into a smaller display window on the screen, which is called “picture-in-picture” (PIP) that is a popular feature for today's television system. If the user is intrigued by the displayed message, he or she may select the message for further reviewing in a manner similar to a user selecting a conventional programming shown in the PIP. If the advertisement in PIP is selected, the advertisement is then re-displayed on the screen replacing the previous selected television programming. Furthermore, more detailed information of the advertisement may be presented to the user including broadcasting a multi-media programming about the advertisement. On the other hand, the PIP is removed after a predetermined period of time if it is not selected by the user for the further reviewing.

In the preferred embodiment, advertisements are delivered from the advertisement server and are stored in the set top box. In another embodiment, the advertisements are stored in the server and are delivered to the set top box upon a request from the computing device after receiving the signal that the user is in touch with the remote control. The advertisements that are displayed on the switching-on screen but are not selected and reviewed by the user are removed from the storage system. They are replaced by new ones from the advertising server. If an advertisement is indeed selected by the user, more advertisements closely related to the selected one may be delivered to and be stored in the set top box for the further usages. Such an iterative way of selecting advertisements helps to build up an advertisement database which tracks the user's topic of interest. For a client system associated with multiple users, each user may have a corresponded user profile and an associated advertisement file tailored to specific interests of each user.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of an information retrieval system for rendering advertisements to its users, wherein an advertising server operated by an advertisement broker is connected to a client system through a communication network. The client system includes a computing device, a television terminal and a remote control.

FIG. 2 is a schematic diagram of a remote control including a sensory system and a sensor data management module.

FIG. 3 is a schematic diagram illustrating a typical event of the position and orientation change of a remote control when hold by a user. The event can be detected by an integrated accelerometer.

FIG. 4 is a schematic diagram of an embodiment employing sensors to detect the user's action of holding the remote control. The sensors are placed on the sidewalls of the remote control.

FIG. 5 is a schematic diagram of an embodiment illustrating a series of changes of the television terminal from a screen with a displayed advertisement to a screen with the user selected channel programming and to a screen with the detailed advertisement messages presented. The displayed advertisement is moved to a “picture-in-picture” window on the screen when the selected channel programming is displayed.

FIG. 6 is a flow diagram illustrating a process that an advertisement is rendered to a user by the use of the switching-on screen of television terminal of a client system.

FIG. 7 is a schematic diagram of a remote control integrated with a biometrical sensory system. Exemplary cases for the sensory system are finger-print sensors on the sidewalls and/or an image capturing device on the front side of the device.

FIG. 8 is a flow diagram illustrating a process that a targeted advertisement is rendered to a user by the use of the switching-on screen of television terminals of a client system, which includes a remote control integrated with biometrical sensors.

FIG. 9 is a flow diagram illustrating a process that recommended advertisements for a user can be adjusted dynamically based upon the user's history of selections.

### DETAILED DESCRIPTION

References will now be made in details to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

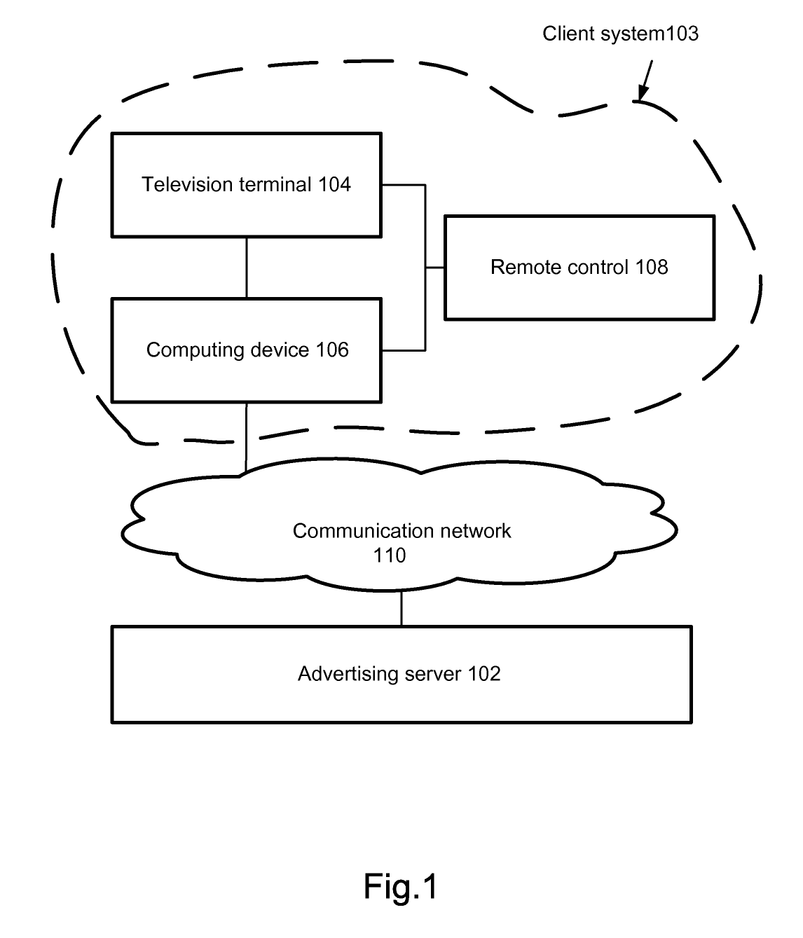

As shown in FIG. 1, the information retrieval system 100 comprises an advertising server 102 operated by an advertisement broker and a client system 103 with a television terminal 104, a computing device 106 and a remote control 108. The computing device 106 of the client system 103 is connected to the server 102 via a communication network 110, which is the Internet in our preferred embodiment. The server 102 is also connected to multiple advertisers who subscribe to the advertisement broker for delivering the advertisements to users of the client systems. The computing device 106 is taken as a set top box in our preferred embodiment. In one implementation of the invention, the computing device 106 is a standalone device connected to the television terminal 104. In another implementation of the invention, the computing device 106 is integrated with the television terminal 104. The computing device 106 includes typically a microprocessor, a file storage system and various communication devices that may connect to the Internet 110, to the remote control 108 and to the television terminal 104. The computing device 106 receives TV programs and advertisements from the server. It stores received information in the storage system and controls the operations of broadcasting programming and displaying advertisements on the television terminal 104.

In various embodiments of the invention, advertisements may include text, graphics, video, audio and multimedia messages. It should be appreciated that while advertisement messages are used herein as exemplary embodiments of the invention, any document may be used in accordance with the various embodiments. For instance, documents such as advertisements, content pages, search results, emails, IM messages, audio content or files, video contents or files, other data or applications that may reside on one or several of computer systems, or other definable concepts or content may be used. Thus although the use of advertisements are described herein as examples, other documents such as web pages may be targeted to viewers and displayed in accordance the various embodiments, e.g. as described herein with respect to advertisements.

It should be understood that an advertisement as used herein may comprise audio and/or video signals, static and/or dynamic images, graphics, video, film, or other content that relate to one or more products, services, and/or entities, such as commercial entities. Advertisements may also comprise various visual features, including animation, sound etc., and may include text, such as in a text advertisement. Thus, the term “advertisement” is used herein in its broadest sense to include any content or object intended for observation, use, or consumption by one or more persons for the purpose of marketing or promoting a product or service. While, advertisements are used for exemplary purpose, it should be understood that any audio and/or video content, such as television programming, may be used with the systems and methods described herein.

Although a single server and a single client system are depicted in FIG. 1 for the purpose of simplicity, the present invention may be based upon a system with multiple servers as well as multiple client systems. In one embodiment, the remote control 108 may communicate to the computing device 106 only and the computing device 106 communicates with the television terminal 104. In another embodiment, the remote control 108 may communicate with the television terminal 104 and the computing device 106 concurrently.

The television terminal 104 may be connected to the computing device 106 via a wired connection including an IEEE 1394 type of connection. In an alternative implementation, the terminal 104 may be connected to the computing device 106 via a wireless connection which conforms to various IEEE standards including IEEE 802.11, IEEE 802.15.1 and IEEE 802.15.4 as well as their amendments.

The computing device 106 may be connected to the Internet via a wired broadband connection or it may be connected via a wireless broadband connections.

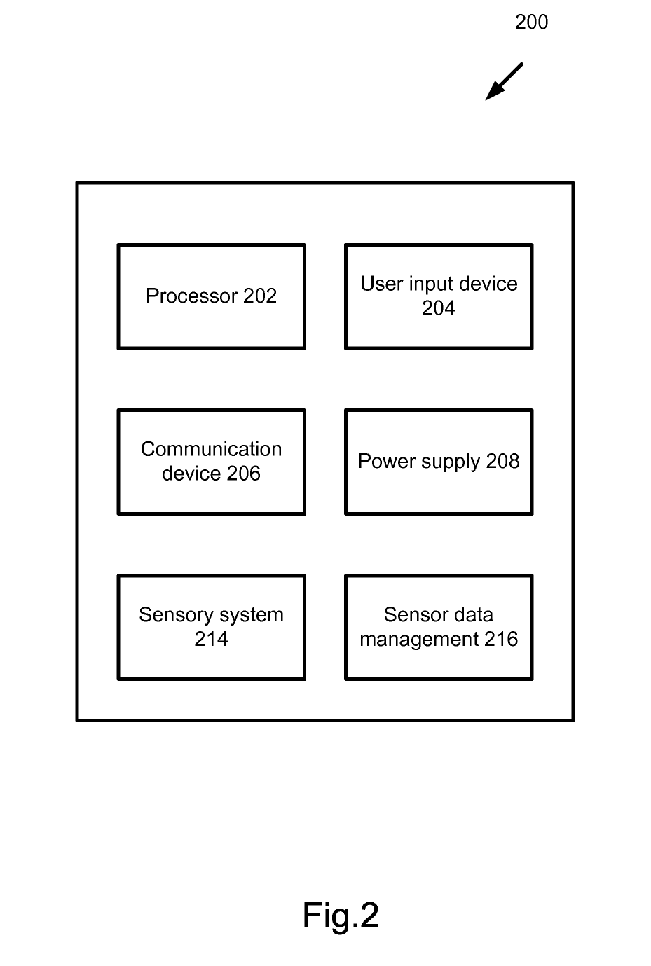

FIG. 2 is a schematic diagram of the remote control 200. The device includes a processor 202 that controls the operation of the device and a user input device 204 that comprises mainly keys and buttons to receive the user's input actions. One or a plurality of communication devices are integrated to communicate with the computing device 106 and/or the television terminal 104. The communication between the remote control and the computing device may take various forms including optical links and wireless connections such as for example, a Bluetooth connection. A power supply 208, which is typically a battery, is used to provide power supply for the device. The remote control 200 further comprises a sensory system 214 and a sensor data management module 216. In one embodiment, the sensory system 214 comprises one or a plurality of sensors for detecting a user's action of holding the remote control. In another embodiment, the sensory system comprises one or a plurality of accelerometers for detecting the movement of the remote control associated with the action that the user picks up the remote control from a still status and holds the device to get ready for an input action.

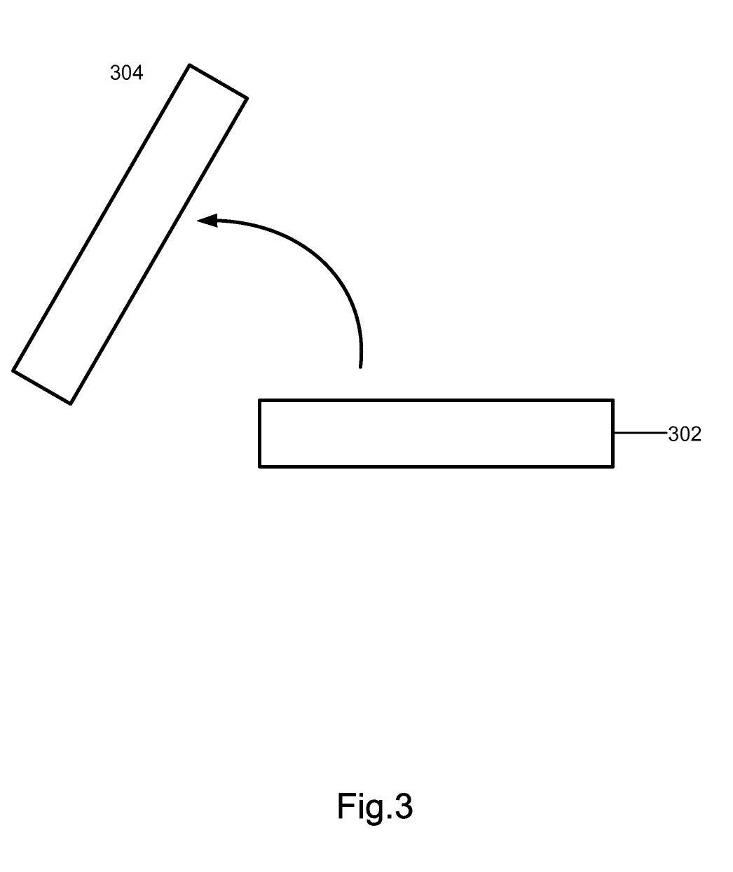

FIG. 3 is a schematic diagram illustrating a typical event of the position and orientation change of a remote control when using by the user. In the user's action to grasp the remote control and to hold it and to position it for the user's input action, the device has typically the movements associated with the change of orientation from a position 302 to a position 304. In the present invention, accelerometers are placed in the remote control to detect such position and orientation changes and, consequently, to correlate the measurements with the user's actions for holding and positioning the device. The cost of silicon-based accelerometer has reduced significant recently. Some of the mobile devices such as for example, the iPhone from Apple Inc have already included accelerometers in the device for detecting the orientation change of the mobile device and for adjusting the display accordingly.

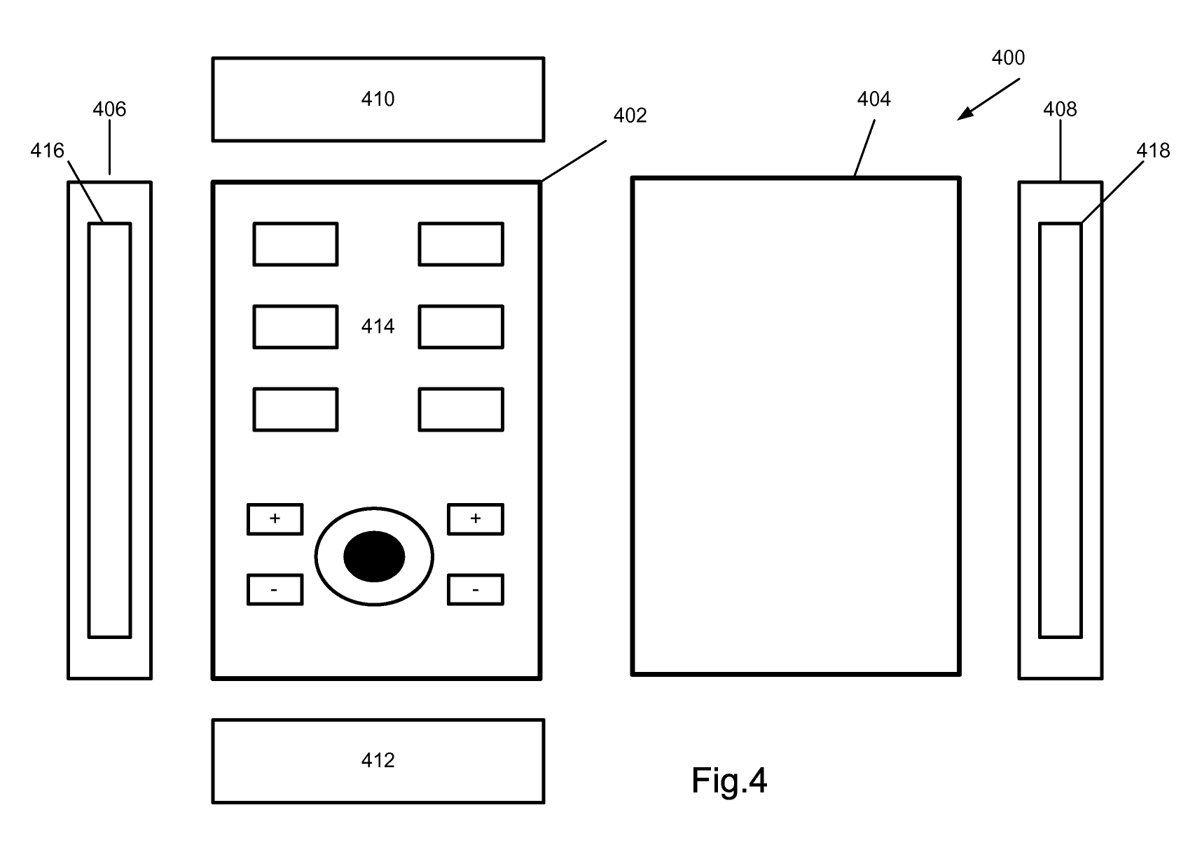

FIG. 4 is a schematic diagram of an embodiment employing sensors to detect the user's action of holding the remote control. As shown in FIG. 4, according to one implementation of the remote control, the device includes a house that consists of a front surface 402 for a user input device 414, a back surface 404, a right sidewall 406 and a left sidewall 408, a top sidewall 410 and a bottom sidewall 412. The sensors 416 are placed at the left sidewall 406 and the sensors 418 are placed at the right sidewall 408. The number of sensors and positions of placement can be selected to ensure that at least one sensor is in contact with the user's hand. In such an implementation, the sensors detect the user's holding and positioning actions and the signals are processed by the sensor data management module and are transmitted to the computing device 106 via wireless means as described previously.

The sensors 416 and 418 may be implemented with different embodiments. In one embodiment, the sensors are pressure sensors, which may be silicon-based sensors manufactured by an Integrated-Circuit-based process. The cost of silicon pressure sensors has been reduced significantly in recent years and the placement of the sensors into mobile devices is becoming affordable. In another embodiment, the sensors may be pressure sensors, of which the house of the remote control can be used as a part to detect a human interaction induced pressure. For example, large capacitors can be placed along the sidewalls of the device. The surface materials may comprise one electrode of the capacitor. When the pressure is applied by a human hand in touch with the device, the sidewall materials containing at least one of the electrodes of the capacitor are deformed slightly. The changes of the capacitance can be detected by electronic circuits integrated with the device as well as connected to the sensing capacitors.

In yet another embodiment, the sensors are touch-screen type of sensors. The principle has been applied to the touch-screen type of display, which has gained significant popularity in recent years. In one implementation, the touch-screen type of sensors is a capacitive sensor. A human hand is a capacitor from a point of view of electrical components. The charge stored in a sensing capacitor is changed when a human hand is in touch with the sensing capacitor.

In yet another embodiment, a plurality of photo-detectors can be placed onto the sidewall of the remote control. When a user is holding the device, at least one of the photo-detectors is covered by the user's hand. As a result, at least one of the photo-detectors senses the change of the ambient light intensity. Photo-detectors have been used in mobile device as a part of the digital camera system.

In an alternative implementation, the sensors may also be placed at the selected positions of the backside of the device to sensor the user's action to hold and to position the device for the user input actions. A combined placement of the sensors on the sidewalls and on the back surface may help to improve the reliability of the detection. Furthermore, a combination of different types of sensors may help to improve the sensitivity and reliability of the detection.

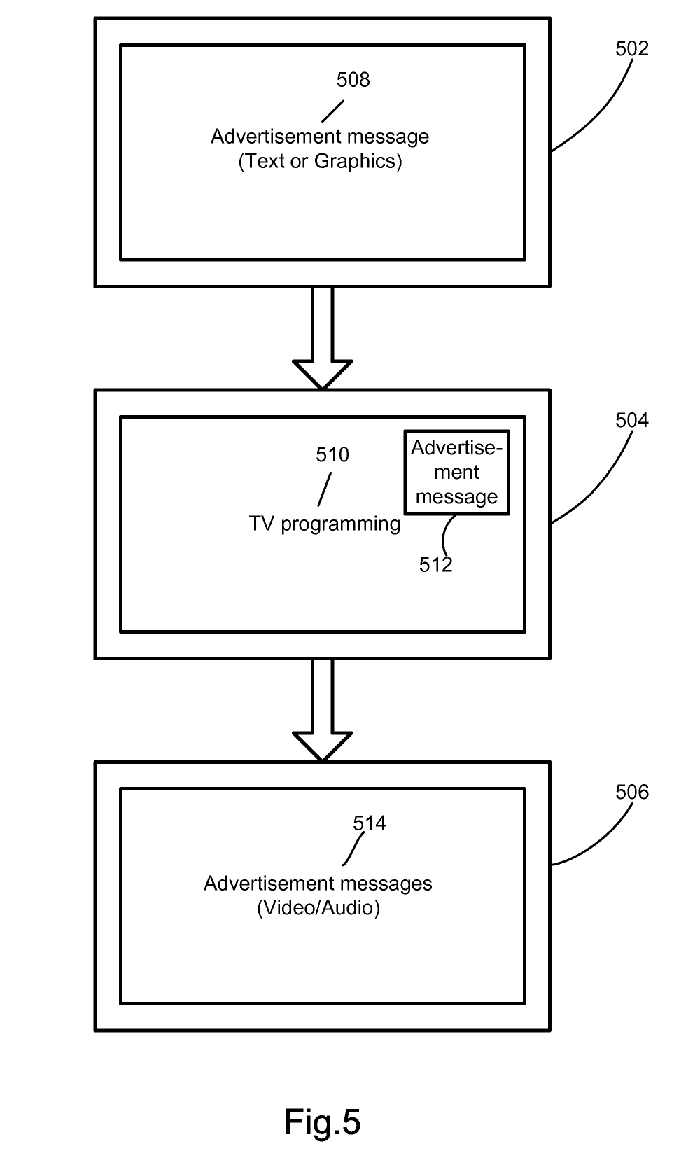

FIG. 5 is a schematic diagram of an embodiment illustrating the changes of the television terminal with different screens of displayed contents. After the computing device 106 receives a signal from the remote control which senses that a human hand is in touch with the device, the processor in the computing device selects an advertisement and controls an operation of switching on and displaying the advertisement on the television terminal as shown in 502. The displayed advertisement 508 is typically a text or a graphic message, which may attract the user's attention quickly. Following by the user selection of a TV channel, a TV programming 510 is broadcasted via the terminal as shown in 504. The displayed advertisement is moved into a smaller display window 512 on the screen, which is called “picture-in-picture” (PIP). The user may select to view the PIP for more detailed information associated with the advertisement. If selected, the advertisement may be presented in a video/audio format 514 as shown in 506. The PIP is removed from the screen if the user's selection is not received after a predetermined period of time.

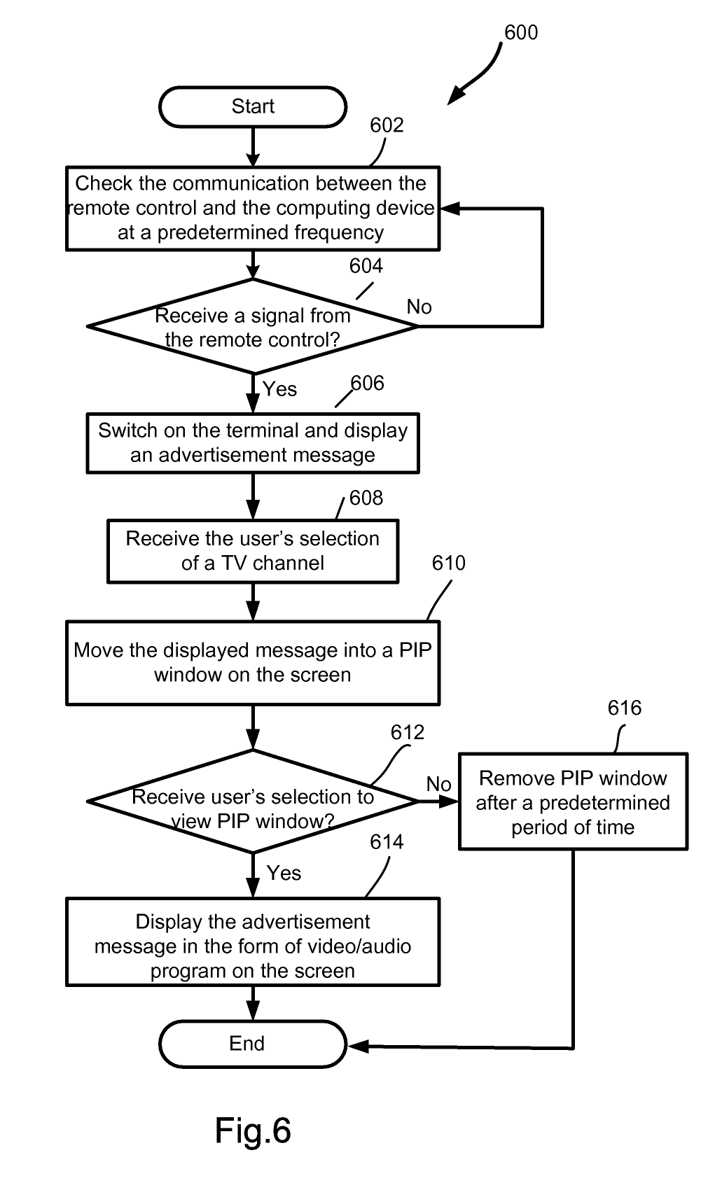

FIG. 6 is a flow diagram illustrating a process 600 that an advertisement is rendered to a user by employing of client system with a television terminal. The process starts with step 602 that the processor of the computing device checks the communication between the remote control and the computing device at a predetermined frequency. If the signal is received in step 604 that the user's hand is holding the remote control, the computing device switches on the television terminal and displays a selected advertisement on the screen in step 606. The computing device receives the user's selection of a television channel in step 608 and replaces the displayed message with the selected channel programming. The displayed advertisement message is moved into a PIP window in step 610. The user may be intrigued by the displayed message and decides to view the message further in step 612. The next level of detailed information may be presented in a manner including a video/audio presentation of the advertisement in step 614. On the other hand, if the advertisement in PIP is not selected by the user in step 612, the PIP window is removed in step 616 after a predetermined period of time.

A television terminal is a home appliance typically with several family members as its users. Each user may have different topic of interest. In the computing device, each user may be assigned with a specific user profile. Each user may have a list of advertisements which fit his or her interests. In one of the embodiments of the present invention, a remote control is disclosed, which can be used to collect biometrical data of the user and to send the data to the computing device for further analysis to determine the user's identity. There are various implementations of the invention, for example, the collected biometrical data can be analyzed locally by using the processor in the remote control and the results are sent to the computing device. In yet another embodiment, the received biometrical data may be sent to the server in the network for further analysis to determine the user's identity.

In another aspect of the invention, the advertisements are selected based upon the user's profile. Such a profile may include but not limit to the demographic information, the recent history about television programs that the user viewed and the recent history about the advertisements that the user viewed. In one implementation, a category of advertisement files associated with each user is stored in the computing device. In another implementation, the categories may be stored in the server and are delivered under the request from the computing device. In such a case, the metadata of the advertisement including title, type and advertiser may be stored in the computing device. In yet another implementation, the computing device may have the first level of information stored, such as for example, the text and graphic information. The more detailed video/audio presentation of the information may be stored in the server and be delivered only after the user selects the message in the PIP window for further reviewing.

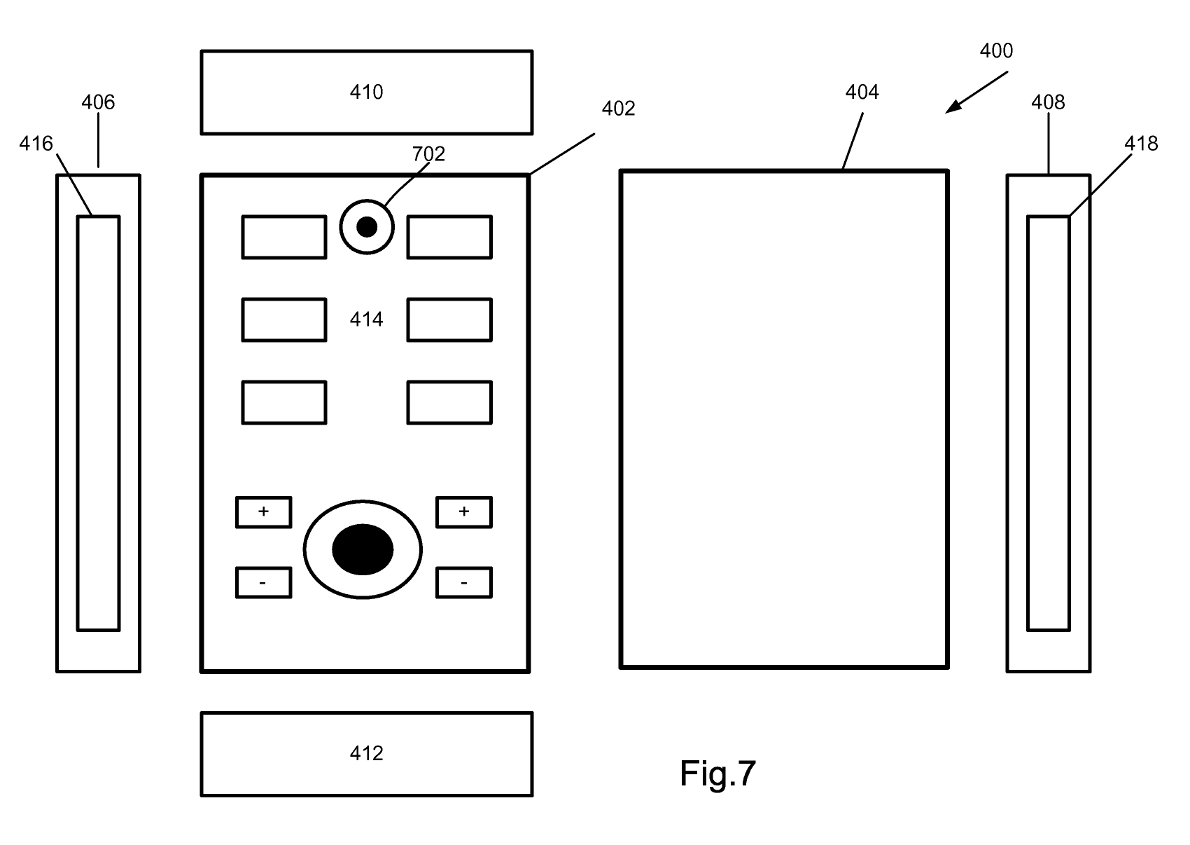

FIG. 7 is a schematic diagram of the remote control with a sensory system for collecting biometrical data of its user. The remote control is integrated with biometrical sensors 416 and 418. The biometrical sensors may be the finger-print sensors assembled onto the sidewalls of the device. When a user's hand is in touch with the device, the sensors collect the user's finger print and send the collected biometrical data to the computing device for the further analysis. In another implementation as shown in FIG. 7, an image capturing device 702 installed onto the front side of the device may be used to capture the facial image of the user. A plurality of the devices may be used to improve the effectiveness of imaging capturing process. Furthermore, the finger-print sensors and the imaging capturing device can be used in combination to determine the user's identity in a more reliable manner.

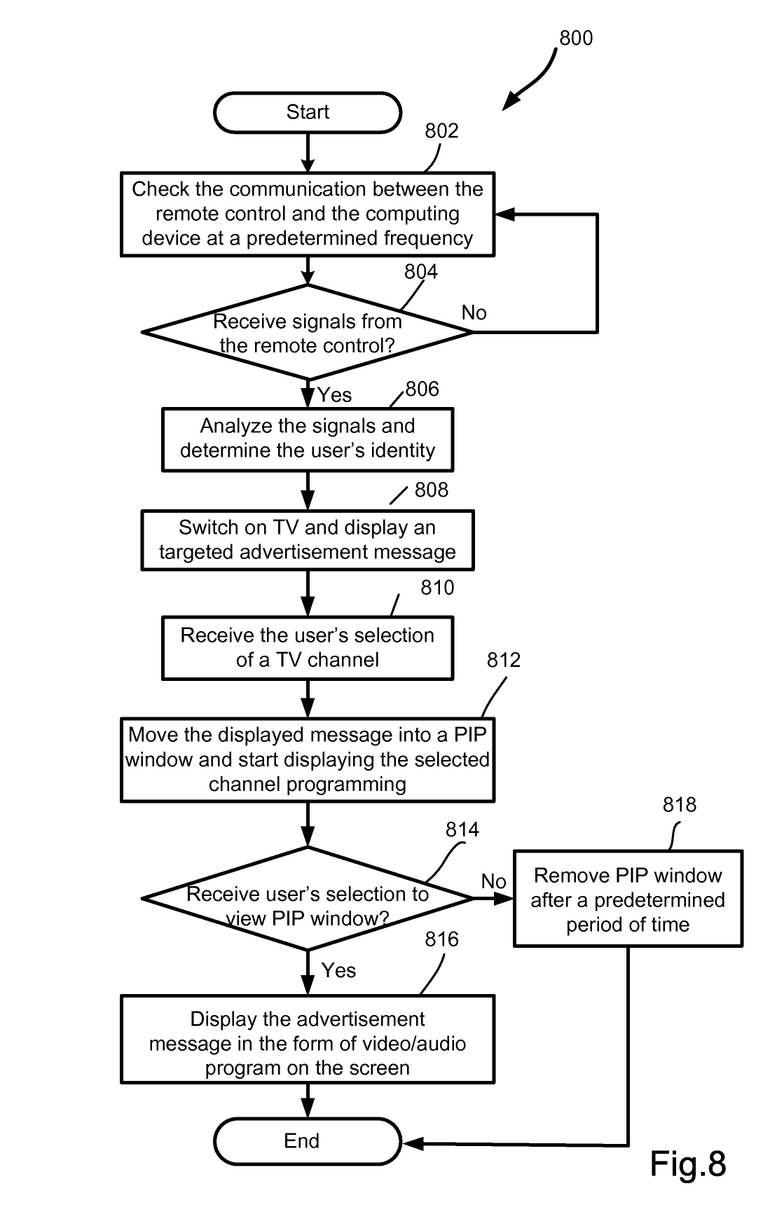

FIG. 8 is a flow diagram illustrating a process 800 that a targeted advertisement is presented by the use of the client system with the capability of identifying a specific user from a group. The client system comprises a computing device, a television terminal and a remote control with an integrated sensory system for collecting biometrical data of the user. The process 800 starts with step 802 that the processor in the computing device checks the communication between the remote control and the computing device at a predetermined frequency. The frequency needs to be sufficiently high that the signal sent from the control can be captured immediately. If the signals characterizing the user's biometrical data are received by the computing device in step 804, they are subsequently analyzed by its processor. The user's identity can then be determined in step 806. The processor selects an advertisement based upon the user's identity and its associated profile which is stored previously and switches on the television terminal and displays the advertisement in step 808. The computing device receives the user's selection of a television channel in step 810 and replaces the displayed message with the selected channel programming. The displayed advertisement is then moved into a PIP window in step 812. If a user's instruction is received to view the message displayed in the PIP window further in step 814, it may be re-displayed in full screen in the form of video/audio programming in step 816. If the advertisement is not selected by the user in step 814, the PIP window is removed after a predetermined period of time.

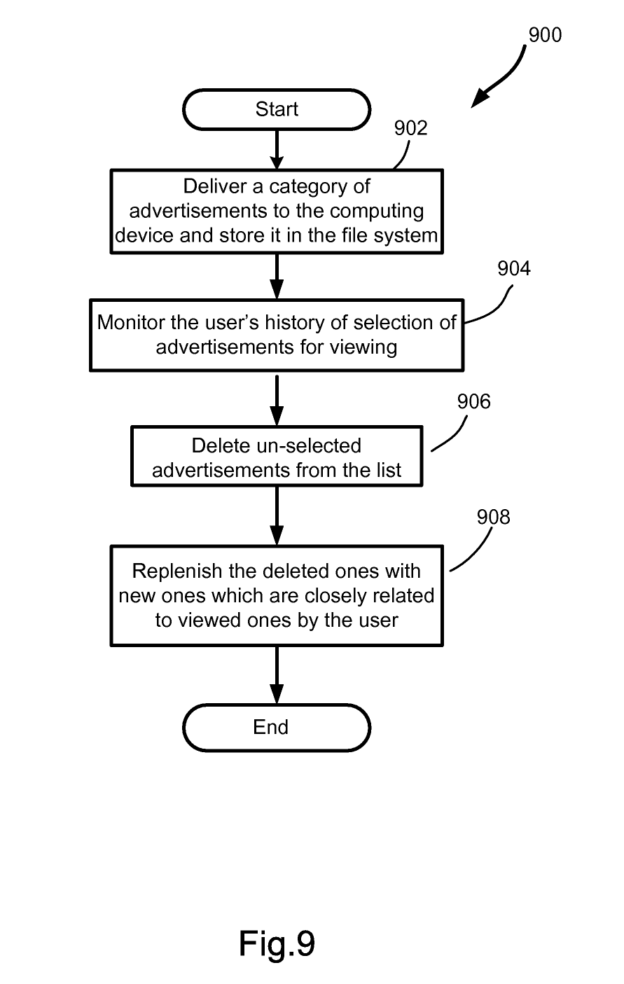

As described previously that the advertisements for each user is determined based upon the specific user's profile. One of the important factors to select the advertisements is the user's history of the selection of the advertisements. FIG. 9 is a flow diagram illustrating a process 900 that advertisements received and stored by the computing device can be adjusted dynamically based upon the user's historical selection patterns. The process 900 starts with step 902 that the initial category of the advertisements is sent to the computing device and is stored therein based upon the user's profile. In step 904, the user's history of selection of the recommended advertisements is monitored and analyzed. The un-selected advertisements are deleted from the category in step 906. New advertisements are added to the list in step 908, which may be closely related to the advertisements selected and viewed by the user.

1. A method of rendering at least one advertisement message to a user using an information retrieval system comprising at least one client system and at least one advertising server connected through a communication network and the client system further comprising at least one television terminal, at least one computing device and at least one remote control, the method comprising:
sensing the user's action of holding the remote control and;
receiving a signal from the remote control by the computing device and;
switching on the television terminal and;
displaying at least one advertisement message on the television terminal.

2. The method as recited in claim 1, wherein the method further comprising:
receiving the user's selection of a channel programming by the remote controller and;
displaying the selected channel programming while moving the displayed advertisement message into a smaller display window on the screen of the terminal and;
receiving the user's selection and replacing the channel programming with the advertisement message or;
removing said smaller display window after a predetermined period of time if the user's selection for viewing is not received.

3. The method as recited in claim, wherein the advertisement message replacing the channel programming including:
the original displayed advertisement message and/or a new version of the message in the forms of video/audio presentation.

4. The method as recited in claim 1, wherein said advertisement is selected and delivered from said advertising server based upon:
demographic information of the user and/or;
history of the user's television programming selection and/or;
history of the user's advertisement selection.

5. The method as recited in claim 1, wherein said computing device is connected to the television terminal through a wired or wireless means and is connected to at least one advertising server by a wired or wireless means through a communication network.

6. The method as recited in claim 1, wherein said communication network including the Internet.

7. The method as recited in claim 1, wherein said computing device is a set top box.

8. The method as recited in claim 1, wherein said remote control including:
a user input device that receives the user's input actions and;
a processor that controls operations of the remote controller and;
a communication device that communicates with the computing device and the television terminal and;
a sensory system that detects the user's action of holding the device.

9. The method as recited in claim 1, wherein said sensory system in the remote controller including:
one or a plurality of touch-screen type of sensors or;
one or a plurality of pressure sensors or;
one or a plurality of photo-detectors or;
one or a plurality of accelerometers or;
one or a plurality of finger-print sensors or;
one or a plurality of image capturing devices or
any combination of the above sensor or sensors.

10. A method of rendering at least one advertisement to a user using an information retrieval system comprising at least one client system and at least one advertising server connected through a communication network and the client system further comprising at least one television terminal, at least one computing device and at least one remote control, the method comprising:
collecting the user's biometrical signals when the user is holding and positioning the remote control to get ready for an input action and;
receiving the collected signals from the remote control by the computing device and;
switching on the television terminal and;
displaying at least one advertisement message on the television terminal based upon the user's identity determined by the received biometrical signals.

11. The method as recited in claim 10, wherein the method further comprising:
receiving the user's selection of a channel programming from the remote control and;
displaying the selected channel programming while moving the displayed advertisement message into a smaller display window on the screen of the terminal and;
receiving the user's selection and replacing the channel programming with the advertisement message or;
removing said smaller display window after a predetermined period of time if the user's selection for viewing is not received.

12. The method as recited in claim 10, wherein said advertisement is selected and delivered from said advertising server based upon:
demographic information of the user and/or;
history of the user's television programming selection and/or;
history of the user's advertisement selection.

13. The method as recited in claim 10, wherein said remote control including:
a user input device that receives the user's input actions and;
a processor that controls operations of the remote control and;
a communication device that communicates with the computing device and the television terminal and;
a sensory system that collects the user's biometrical signals.

14. The method as recited in claim 10, wherein said biometrical signals of the user are collected by the sensory systems, including:
one or a plurality of finger-print sensors that collect the user's finger prints and/or;
one or a plurality of image capture devices that collect the user's facial images.

15. A remote control including features for sensing a user's action for holding said remote control, the device comprising:
a user input device providing means to receive a user's input actions and;
a processor providing means to control operations of the device and;
a power supply providing power for the operations of the device and;
a sensory system to provide means for sensing said the user's hand is in touch with the remote control and;
a data management unit for said sensory system.

16. The remote control as recited in claim 15, wherein the sensory system including biometrical sensors that collect the user's biometrical information and said biometrical sensors further include finger print sensors and/or image capturing devices.

17. The remote control as recited in claim 15, wherein said sensory system including one or a plurality of pressure sensors and/or one or plurality of touch-screen type of sensors located on selected positions of the device.

18. The device as recited in claim 15, wherein said sensory system including one or plurality of accelerometers providing means to sense movements of the device associated with a user's operation of holding the device for the user's input actions.

19. The device as recited in claim 15, wherein said sensory system including one or a plurality of photo-detectors located in selected positions of the device.

20. The device as recited in claim 15, wherein said sensory system comprising a plurality of sensors including any combination of said pressure sensors, said touch-screen type of sensors, said accelerometers, said photo-detectors and said biometrical sensors.
